(19) United States
(12) Patent Application Publication
(10) Pub. No.: US 2016/0220907 A1
(43) Pub. Date: Aug. 4, 2016

(54) COMPUTER IMPLEMENTED GAME

(71) Applicant: KING.COM LIMITED, St. Julians (MT)

(72) Inventors: Teemu Ikonen, Singapore (SG); Abel XUAN HUI TAN, Singapore (SG)

(21) Appl. No.: 14/884,833

(22) Filed: Oct. 16, 2015

(30) Foreign Application Priority Data
Oct. 16, 2014 (GB) 1418393.3

(51) Int. Cl. A63F 13/67; A63F 13/537

(52) U.S. Cl. CPC A63F 13/67; A63F 13/537

(57) ABSTRACT

A device has a display which displays game objects. The device also has a user interface which is able to receive an input from a user to select one speed mode for the one or more game objects. A processor determines if one or more conditions are satisfied. If so, movement of at least one of the game objects is controlled when displayed on the display in dependence on the speed mode selected by the user input.

### CROSS-REFERENCE TO RELATED APPLICATIONS

This application is based on, and claims priority to, Great Britain Application No. GB 1418393.3, filed Oct. 16, 2014, the entire contents of which being fully incorporated herein by reference.

### FIELD OF THE INVENTION

Some embodiments may relate to a system for providing a computer implemented game.

### BACKGROUND OF THE INVENTION

Computer implemented games are a well-known category of games that allow a player to interact with a computing device to cause the processor to perform certain functions and typically display a result on a screen or other display device.

Different types of games have evolved from classical arcade games in to games that can be played on a handheld device such as a smartphone, tablet or personal computer. Some games are also connected to the Internet and the player can play against or compare score with other users in multiplayer mode.

### SUMMARY OF INVENTION

In one embodiment, there is provided a system for providing a computer implemented game having a plurality of game objects which in use are displayed on a display, said system comprising: an input configured to receive an input from a user; a game engine part configured to be responsive to the received input, said game engine being configured to determine one of a plurality of speed modes; a physics engine configured to control movement of at least one of said plurality of game objects, said physics engine being configured to control the movement of said at least one of said plurality of game objects in dependence on the speed mode determined by said game engine.

In some embodiments, the game engine may be configured to detect at least one event associated with at least one object. The at least one event may comprise determine a collision of said at least one object with at least one other object.

In some embodiments a number of events is recorded. Alternatively or additionally a value is associated with each event. The number of events or the value associated with each event may be stored in memory, for example a register of said system.

In some embodiments, the game engine may be configured to determine if the number of events or the value surpasses or equals a pre-determined threshold value. In other embodiments, a countdown method may be used by the game engine to measure the number of events or value in which case the number of events or values may need to get to zero or below a given threshold.

The game engine may be configured to detect when the threshold has been met, that a user input has been provided via the user interface.

The game engine may be configured to select a different one of said speed modes, on receiving the user input. This may be a slower speed mode.

In some embodiments the game engine may be configured to initiate a timer on receiving the user input.

In some embodiments the game engine is configured to detect that the user input has ended or that the timer has reached a predefined value.

In response thereto, the game engine may be configured to change the speed mode. This may be a higher speed mode.

In some embodiments the game engine may be configured to trigger an effect associated with first game object on detecting that the user input has ended or that the timer has reached a predefined value

In some embodiments, the events detected are one or more of a collision of a first game object with a second game object, a collision of a first game object with a boundary object, the boundary object restricting movement of game objects, and a first game object with another first game object.

In some embodiments, changing the speed mode comprises modifying a parameter associated with a number of pixels per second an object in motion is moved by the physics engine.

In some embodiments the physics engine sets the first game object to a stationary state on detecting that the user input has ended or that the timer has reached a predefined value.

In one embodiment, there is provided a method for providing a computer implemented game having a plurality of game objects which in use are displayed on a display, said method comprising: receiving an input via a user input; determining one of a plurality of speed modes; and controlling movement of at least one of said plurality of game objects in dependence on the determined speed mode.

In some embodiments, the method may comprise detecting at least one event associated with at least one object. The at least one event may comprise determine a collision of said at least one object with at least one other object.

In some embodiments a number of events is recorded. Alternatively or additionally a value is associated with each event. The number of events or the value associated with each event may be stored in memory, for example a register.

In some embodiments, the method may comprise determining if the number of events or the value surpasses or equals a pre-determined threshold value. In other embodiments, a countdown method may be used to measure the number of events or value in which case the number of events or values may need to get to zero or below a given threshold.

The method may comprise detecting, when the threshold has been met, a user input through a user interface.

The method may comprise selecting a different one of said speed modes, on receiving the user input. This may be a slower speed mode.

In some embodiments the method comprises initiating a timer on detecting the user input.

In some embodiments the method, further comprises detecting that the user input has ended or that the timer has reached a predefined value.

In response thereto, the method may comprise changing the speed mode. This may be a higher speed mode.

In some embodiments the method further comprises triggering an effect associated with first game object on detecting that the user input has ended or that the timer has reached a predefined value

In some embodiments, the events detected are one or more of a collision of a first game object with a second game object, a collision of a first game object with a boundary object, the boundary object restricting movement of game objects, and a first game object with another first game object.

In some embodiments, changing the speed mode comprises modifying a parameter associated with a number of pixels per second an object in motion is moved.

In some embodiments the method further comprises setting the first game object to a stationary state on detecting that the user input have ended or that the timer has reached a predefined value.

In some embodiments, a computer program is provided, said computer program comprising computer code which when run causes any of the above methods to be performed.

According to another aspect, there is provided an apparatus for providing a computer implemented game having a plurality of game objects which in use are displayed on a display said apparatus comprising at least one processor and at least one memory including computer code for one or more programs, the at least one memory and the computer code configured, with the at least one processor, to cause the apparatus at least to: receive an input via a user input; determine one of a plurality of speed modes; and control movement of at least one of said plurality of game objects in dependence on the determined speed mode.

The at least one memory and the computer code may be configured, with the at least one processor, to detect at least one event associated with at least one object. The at least one event may comprise determine a collision of said at least one object with at least one other object.

In some embodiments a number of events is recorded. Alternatively or additionally a value is associated with each event. The number of events or the value associated with each event may be stored in memory, for example a register.

The at least one memory and the computer code may be configured, with the at least one processor, to determine if the number of events or the value surpasses or equals a pre-determined threshold value. In other embodiments, a countdown method may be used to measure the number of events or value in which case the number of events or values may need to get to zero or below a given threshold.

The at least one memory and the computer code may be configured, with the at least one processor, to detect, when the threshold has been met, a user input through the user interface.

The at least one memory and the computer code may be configured, with the at least one processor, to select a different one of said speed modes, on receiving the user input. This may be a slower speed mode.

The at least one memory and the computer code may be configured, with the at least one processor, to initiate a timer on detecting the user input.

The at least one memory and the computer code may be configured, with the at least one processor, to detect that the user input has ended or that the timer has reached a predefined value. In response thereto, he at least one memory and the computer code may be configured, with the at least one processor, to change the speed mode. This may be a higher speed mode.

The at least one memory and the computer code may be configured, with the at least one processor, to trigger an effect associated with first game object on detecting that the user input has ended or that the timer has reached a predefined value

In some embodiments, the events detected are one or more of a collision of a first game object with a second game object, a collision of a first game object with a boundary object, the boundary object restricting movement of game objects, and a first game object with another first game object.

The at least one memory and the computer code may be configured, with the at least one processor, to modify a parameter associated with a number of pixels per second an object in motion is moved to change the speed mode.

The at least one memory and the computer code may be configured, with the at least one processor, to set the first game object to a stationary state on detecting that the user input have ended or that the timer has reached a predefined value.

A computer program product for providing a computer implemented game having a plurality of game objects which in use are displayed on a display, said computer program product comprising computer executable code which when run is configured to: receive an input from a user input; determine one of a plurality of speed modes; and control movement of at least one of said plurality of game objects in dependence on the determined speed mode.

The computer executable instructions may be run on one or more processors.

A non-transitory computer readable medium, comprising computer executable instructions for providing a computer implemented game having a plurality of game objects which in use are displayed on a display, said computer executable instruction which when run cause any of the methods described previously to be performed.

The computer executable instructions may be run on one or more processors.

### BRIEF DESCRIPTION OF THE DRAWINGS

Reference will now be made by way of example only to the accompanying drawings in which:

FIG. 1 shows an example user device in which some embodiments may be provided;

FIG. 2 shows an example system in which some embodiments may be provided;

FIG. 3 is a schematic diagram showing the modules and functions associated with carrying out the operating of embodiments;

FIGS. 4 and 5 show examples of game images displayed to the user; and

FIG. 6 is a flow diagram depicting the method steps of some embodiments.

### DETAILED DESCRIPTION OF EMBODIMENTS

In the following description of various implementations, reference is made to the accompanying drawings which form a part thereof, and in which is shown by way of illustration various implementations may be utilized.

The terms user and player are used interchangeably throughout this document and no specific meaning is intended using one or the other unless the context suggests otherwise.

A person skilled in the art will realise that the different approaches to implementing the game is not exhaustive, what is described herein are certain preferred embodiments. It is possible to implement the game in a number of variations without departing from the spirit or scope of the invention.

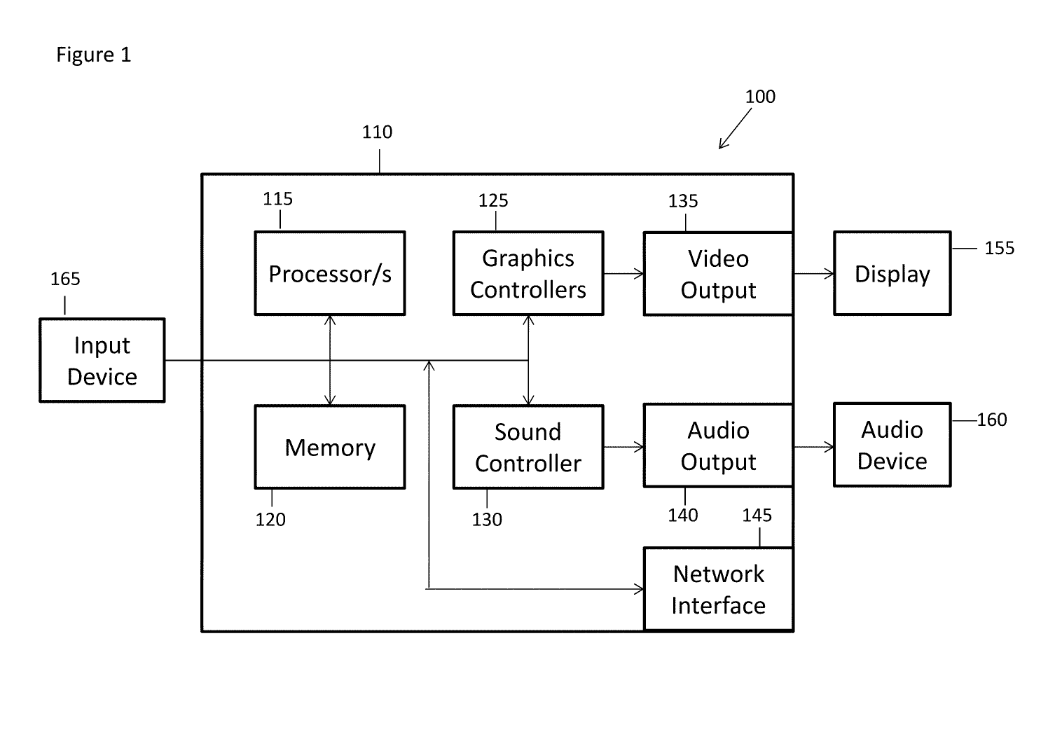

A schematic view of a user device 100 according to an embodiment is shown in FIG. 1. All of the blocks shown are implemented by suitable circuitry. The blocks may be implemented in hardware and/or software. The user device may have a control part 110. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The control part 110 has an interface 145 allowing the device to be able to communicate with a network such as the Internet or other communication infrastructure.

The video output 135 is provided to a display 155. The audio output 140 is provided to an audio device 160 such as a speaker and or earphone(s).

The device 100 has an input device 165. The input device can take any suitable format and can be one or more of a keyboard, audio input, mouse, touch screen, joystick or game controller. It should be appreciated that the display 155 may in some embodiments also provide the input device 165 by way of an integrated touch screen for example.

The blocks of the control part 110 are configured to communicate with each other by an interconnect such as a bus or any other suitable interconnect and/or by point to point communication. The blocks of the controller may be implemented in any suitable way. The blocks of the controller may be regarded as schematically showing one or more functions performed by the control part 110.

It should be appreciated that in some embodiments, the control part may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

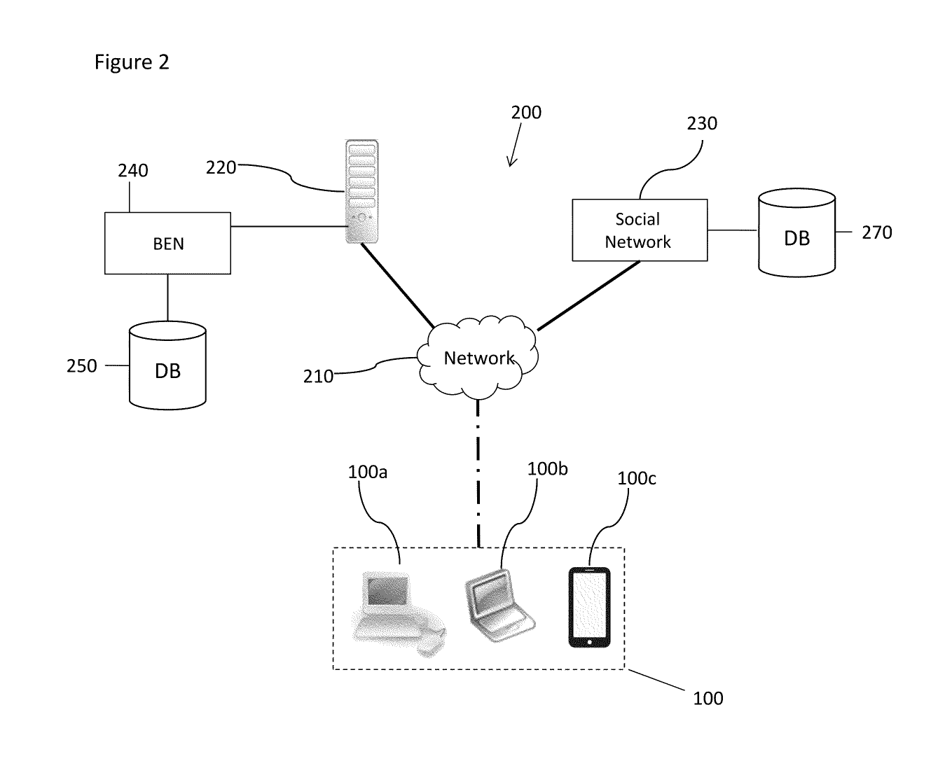

FIG. 2 schematically shows a system 200 according to an embodiment. The system 200 comprises a server 220 which may store or be in communication with database 250. A back end infrastructure (BEN) may be provided between the database 250 and the server 220. The database may store one or more of game player's details, profiles, statistics etc. In practice, one or more databases 250 may be provided. Where more than one server 220 is provided, the database(s) 250 may be provided in one database 250 or across two or more databases. The server 220 may have a games data function. This may comprise one or more units of memory to store the computer game program, user behaviour data and a processor 115 to run the games program and process the user behaviour data.

The server 220 may communicate via, for instance, a communications infrastructure 210 to one or more client or user devices 100, shown in FIG. 2 by way of example as user devices 100a, 100b and 100c. The communications infrastructure may be the Internet or the like. The communications infrastructure may provide connections to a social network 230, for example, Facebook™. The social network 230 may also be connected to a database 270 storing social user interaction details, for instance, user to user interaction maps, friend lists, location history etc. In practice, one or more databases 270 may be provided.

It should be appreciated that embodiments may be deployed in different system architectures. For example, the computer game may be implemented as a computer game that is stored in the memory of the user device and is run on the processor of the user device. However, the server 220 may handle some elements of the game in some embodiments. By way of example only, a Java game applet may be provided to the user device 200 and the locally running Java applet will generate, for example, the graphics, sounds, and user interaction for the game play on the user device. Some data may be fed back to the server to allow interaction with other players. The data which is fed back may alternatively or additionally allow scoring and/or cross platform synchronization.

In some embodiments, the game may be implemented as a computer program that is stored in a memory of the system, for example the server, and which runs on a processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

It should be appreciated that some embodiments may be provided as stand-alone games on the user device. In that case, the game may be implemented at least partially by a computer program stored in memory on the user device and run by the control part 110.

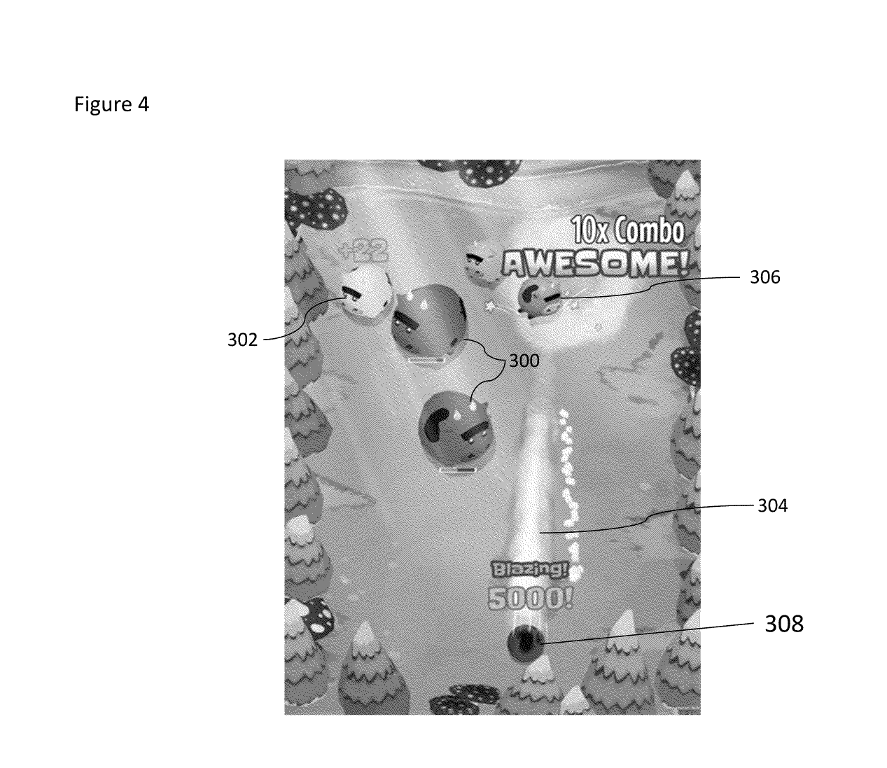

Reference is made to FIG. 4 which schematically shows an image displayed to a user playing a game of an embodiment. In the example that will now be described, the image which is displayed to the user on the display is on a touch screen display. However, it should be appreciated that other embodiments may be implemented with a non-touch screen display. In this latter alternative embodiment, the input device may take any suitable form, examples of which have been previously given.

The image which is displayed has one or more of a first type of object and one or more of a second type of object. The first types of objects are objects which the user is able to select and in the example shown in FIG. 4 are referenced 302, 306 and 308. The second type of objects, referenced 300, in FIG. 4 are provided for the first type object to interact with. In some embodiments, the aim may be for the first set of objects to interact by for example colliding, with the first sets of objects and/or second set of objects and/or stationary objects in order to achieve a desired game object. The stationary objects are, in the example shown in FIG. 4, represented by trees by way of example only.

As will be discussed in more detail later, one of the first objects, e.g. object 302 may be selected by a user. This selected first object is to move. The first object, when selected by the user for movement, will bounce off other objects which may be the first and/or second objects and/or stationary objects.

In some embodiments, the object has a first mode in which the object moves relatively fast and a second mode in which the object moves relatively slowly. In the image which is displayed in FIG. 4, the reference 304 indicates the track of the associated first moving object 308 when in the relatively fast mode. In some embodiments, the first object may move in such a way as to bounce off any other surrounding object in the display.

In order to select the object, the user uses an input device. In the case of a touch screen, the first object which is to be selected is selected by the user placing their finger on that first object. The user is then able to move their finger across the touchscreen. This provides an input to the touch screen which causing the first object to be moved and when the user moves his finger away from the touch screen (e.g. lifting his finger off the touch screen), the first object which is initially dragged by the user interaction with the touch screen is released and moves. The trajectory of the first object is controlled in accordance with the direction in which the user has moved his finger from the initial selection position of the first object to the release position of the first object. In some embodiments, a path for the initial movement of the first object may be displayed.

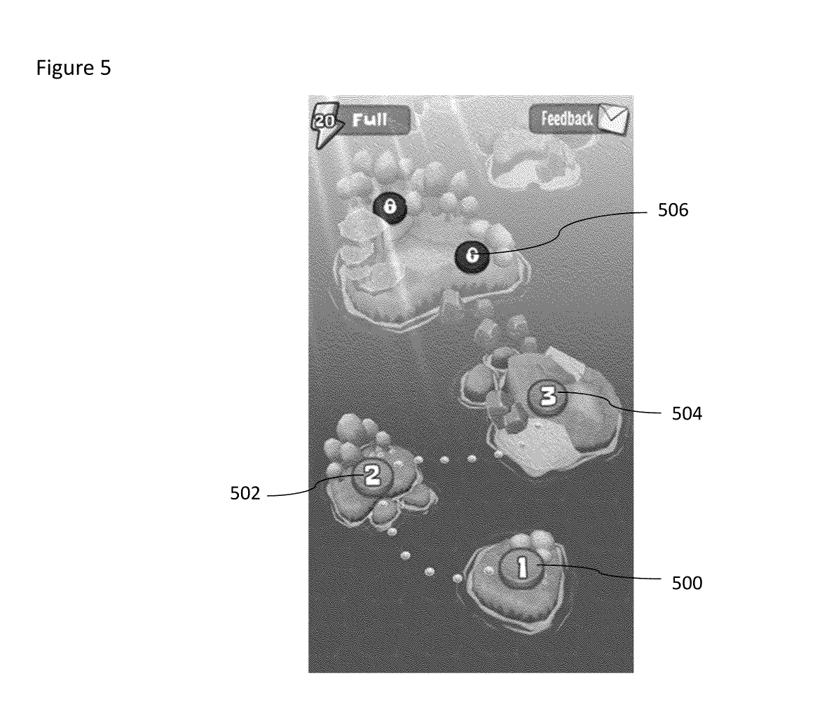

Reference is made to FIG. 5. In some embodiments, the game may have more than one levels. Those levels may be presented on a map. In the example of the image which is displayed on a display of FIG. 5, the first level 500, second level 502 and third level 504 have been completed. The next level 506 is to be unlocked, for example on completion of the previous level.

It should be appreciated that in other embodiments, the game may have a single level.

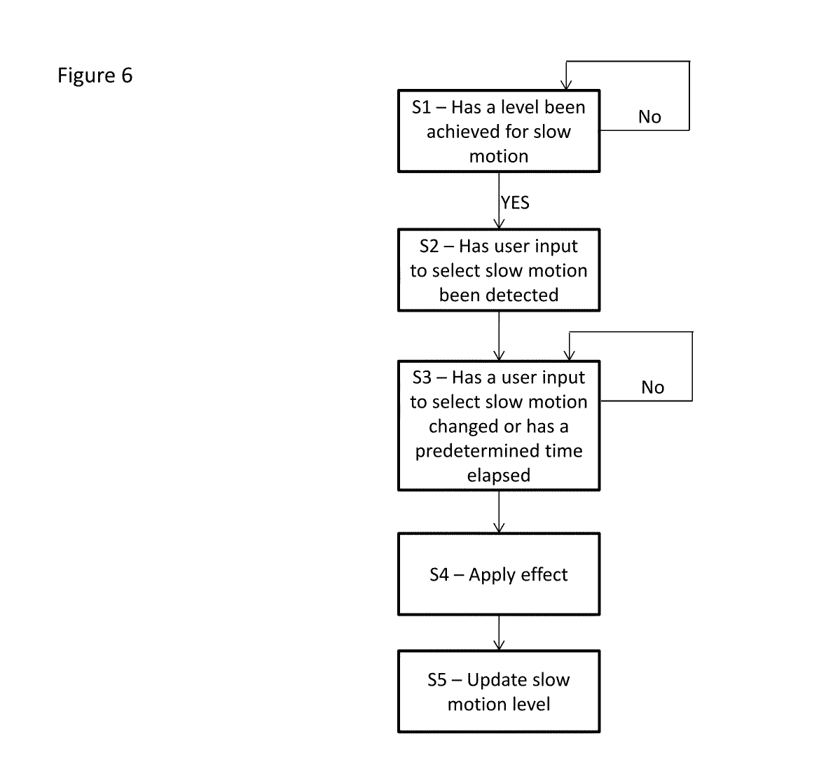

Reference is made FIG. 6 which shows a method of an embodiment.

In some embodiments, a slower mode level or target has to be achieved in order for a user to be able to select a slower mode. This slower mode level or target may be dependent on the number of bounces of a first object against first objects and/or second objects and/or stationary objects which in the example shown in FIG. 4 are trees. A progress bar or similar may be displayed to represent how close a user is to the given target for the slower mode. In other embodiments, the slower mode level or target may be dependent on additional or alternative game actions. In some embodiments, the slower mode level or target may be omitted and a user is able to select a slower mode without achieving the level or target.

In the method shown in FIG. 6, it is determined if the desired slower mode level or target to enter the slower mode has been achieved. If not, the method will loop round and repeat step S1. If so the next step is step S2.

In step S2, a user input is received and the user input is used to determine if the user has selected the slower mode. The user input can be using any of the inputs described earlier. In some embodiments, if the level or target has been achieved and a first object is moving in a faster mode, the user can provide an input to select the slower mode. In the slower mode, the speed at which objects are moved is reduced as compared to the faster mode. In some embodiments the slower mode may for example be of the order of 20% of the speed in the faster mode. Thus if the user has provided an input to select the slower mode and the given slower mode target or level has been reached, the game object(s) will then move at the lower speed of the slower mode.

In some alternative embodiments, steps S1 and S2 may take place generally at the same time. In other embodiments, step S2 may take place before step S1.

In step S3, the game objects will move at the lower speed until either the user input indicates that the slower mode is to be exited or a predetermined amount of time has elapsed. The method may comprise repeatedly carrying out the checks of step S3 until it is determined that the slower mode is to be exited. The user input to indicate that the user is to exit the slower mode can be as previously described and may for example be the lifting of the user finger from a touch screen or the release of a pointer. The predetermined amount of time may be any suitable length of time and may for example be of the order of 5 s.

In step S4, when the slower mode ends, the first object in motion will stop and perform its associated action or function. The associated action can comprise any game function. For example the function may comprise increasing “health” of one or more objects where in the course of a game a reduction in health below a given level may result in the object being removed or rendered ineffective. An alternative function may be a “bomb” function which may result in the removal of one or more game objects. In some embodiments, the function will have an effect in the vicinity of the first object in question. The vicinity may for example be a circular area with a diameter x.

In step S5, after the slower mode has ended, the slower mode level which is compared to the predetermined level is reduced. In some embodiments, the slower mode level is reduced to zero. Thus in some embodiments, after the slower mode has ended the bar or level is empty and needs to be re-charged before the slower mode can be selected again.

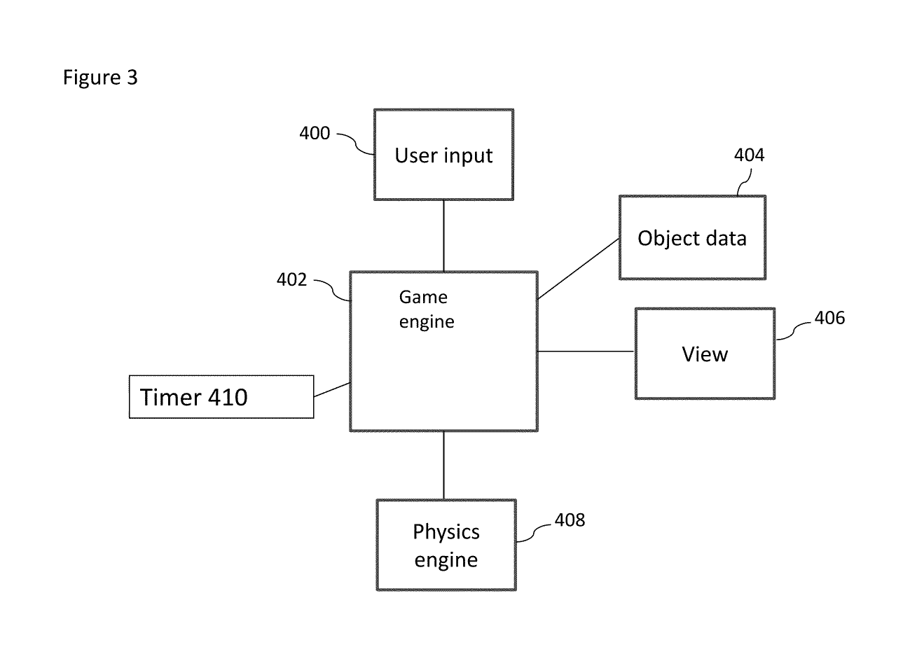

Reference is made to FIG. 3 which is schematically shows the functional blocks of an embodiment. A user input block 400 is shown. This captures the user input and feeds the input to a game engine 402. In the context of this game, this will be determining a position of a pointer or a user's finger in the case of a touch screen. This user input can be via any suitable user interface, such as discussed earlier.

The game engine 402 will process the information provided by the user input. The game engine 402 (for example a game model) will determine if a valid selection of a first object has been made.

Each object has object data associated therewith. The object data 404 may be stored in any suitable memory location. In some embodiments, the object data may be considered to be part of the game engine and in other embodiments may be considered to be outside the game engine. The object data may provide information as to the properties of an object. These properties can include attribute information such as colour and/or whether or not an object has a particular function. The object data may include position data, that is information representing the position of the object in the displayed image.

In some embodiments, the game engine will check if the selection of the game object and/or a selection of a slower mode satisfies the rule or rules required for this mode or selection. The rule or rules will be dependent on the game.

Thus, the game engine will be in control of the determining if a slower mode is selected. The game engine will also be in control of determining if a condition has been satisfied such that the slower mode level which is used to control if the slower mode is available is increased.

A physics engine 408 is provided which is configured to control the movement of the objects. This will be an object which has been released and which collides with one or more other objects. The physics engine will generally manage the movement of object based on for example collision detection, when the object hits another object.

The movement of the object is thus controlled by the physics engine, which will control the movement of an object as it collides and bounces off other objects.

The physics engine will be provided with information from the game engine as to whether to control the object(s) to move at the faster speed or the slower speed. The mode is determined by the game engine and the game engine will provide information to the physics engine.

A view function 406 uses of the object data to provide the displayed image with which the user is able to view and/or interact

Thus the user input is provided to the game engine. The input is used by the game engine to provide movement information to the physics engine to indicate which object has been shot and the direction information. Based on the input, the physics engine will control the movement of one or more objects. The physics engine will have information for each object. In particular, the physics engine will have information, which defines each object as either stationary or moving. If an object is classified as being stationary, the physics engine will not move that object. Thus an object is classed as stationary or moving and this is used by the physics engine. The physics engine will control the moving object(s) but will take into account the position of the stationary objects to control the movement of the moving objects.

Object data, provided in a respective memory location, contains the data from which the game characteristics are defined. By way of example only, the data may identify the position or one or more attributes of the object. One or more attributes may be provided. By way of example only, the attributes may be size, colour, character or the like of the tile. For example, the data comprises X (x coordinate information); Y (y coordinate information); a (where a is one of a set of numbers and each number represents a different colour). The attribute data may not itself be stored with the game object data. In other embodiments, the attribute data may be stored with the game object data. It should be appreciated that the attributes mentioned are by way of example and any suitable attributes may be used in embodiments, dependent on the game.

The example above has numeric values to represent the colour attribute. For example the number 1 may mean red. It should be appreciated that this is by way of example only and any other suitable method may be used to indicate the value or type of a particular attribute. In some embodiments, the data may have n bits where n represents each of the possible values of each of the possible attributes and 1 and 0 are used to indicate if the particular value of an attribute is present.

In some embodiments, a word or collection of letters may be used to indicate a value of the attributes.

A timer 410 is provided. When the slower mode is entered, the timer is started. When the timer reaches a predetermined value, this will cause the slower mode to be ended. The timer may be a count up or a countdown timer.

In some embodiments, the method may comprise detecting a first user input via a user interface of a device. A series of events associated with the first user input may be detected, each event associated with a parameter. In some embodiment, the method may comprise accumulating, in a register of the device, the parameters associated with each detected event. In some embodiments, the method may comprise verifying if the accumulation surpass or equals a pre-determined threshold value. The method may comprise detecting, when the accumulation surpass or equals the threshold value, a second user input through the user interface. The method may comprise reducing, on receiving the second user input, the speed at which the physics engine controls movement of objects.

In some embodiments the method, further comprises initiating a timer on detecting the second user input.

In some embodiments the method, further comprises detecting that the second user input has ended or that the timer has reached a predefined value, and increasing the speed at which the physics engine move objects based on the detection.

In some embodiments, the events detected are one or more of a collision of a first game object with a second game object, or a collision of a first game object with a boundary object, the boundary object restricting movement of game objects.

In some embodiments, reducing, or increasing, the speed at which the physics engine controls movement of objects, comprises modifying a parameter associated with the number of pixels per second an object in motion is moved by the physics engine.

In some embodiments the method further comprises resetting the register on detecting that the second user input has ended or that the timer has reached a predefined value.

In some embodiments the method further comprises triggering an effect associated with first game object on detecting that the second user input has ended or that the timer has reached a predefined value.

In some embodiments the method further comprises setting, by the physics engine, the first game object to a stationary state on detecting that the second user input have ended or that the timer has reached a predefined value.

In other embodiments, the default mode is the slower mode and the faster mode may be selected using for example the method of FIG. 6.

In other embodiments more than two different speed modes may be provided. For example one mode may be a default mode and each other mode may have at least one condition which needs to be met in order to select the respective mode.

It should be appreciated that other embodiments may be used with any other suitable games.

Various methods and devices have been described. It should be appreciated that these methods may be implemented in apparatus or devices comprising any suitable circuitry. Some embodiments may be implemented by at least one memory and at least one processor. For example the arrangement of FIG. 3 may be at least partially or completely implemented by at least one memory and at least one processor.

The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

An appropriately adapted computer program code product or products may be used for implementing the embodiments, when loaded on an appropriate data processing apparatus. The program code product for providing the operation may be stored on, provided and embodied by means of an appropriate carrier medium. An appropriate computer program can be embodied on a computer readable record medium. A possibility is to download the program code product via a data network.

In general, the various embodiments may be implemented in hardware or special purpose circuits, software, logic or any combination thereof.

Embodiments may thus be practiced in various components such as integrated circuit modules.

It is also noted herein that while the above describes embodiments, there are several variations and modifications which may be made to the disclosed solution without departing from the scope of the present invention.

1. A device for providing a computer implemented game having a plurality of game objects which in use are displayed on a display of the device, the device comprising:
a user interface configured to receive an input from a user to select one of a plurality of speed modes for one or more game objects;
a display configured to display the plurality of game objects
at least one processor configured to:
responsive to the received input to select one of a plurality of speed modes, determine if one or more conditions are satisfied; and
if the one more conditions are satisfied, control movement of at least one of the plurality of game objects when displayed on the display in dependence on the speed mode selected by the user input.

2. The device as claimed in claim 1, wherein the at least one processor is configured to detect at least one event associated with at least one object, the one or more conditions being associated with the at least one event.

3. The device as claimed in claim 2, wherein the at least one processor is configured to detect at least one event by determining a collision of at least one object with at least one other object.

4. The device as claimed in claim 2, comprising a memory, the at least one processor being configured to store information associated with at least one of a number of events and a value associated with the one or more events in the memory.

5. The device as claimed in claim 4, wherein the at least one processor is configured to determine if the number of events or the value satisfies the one or more conditions.

6. The device as claimed in claim 1, wherein the at least one processor is configured to select a slower one of the speed modes, on receiving the input from the user to select one of the plurality of speed modes.

7. The device as claimed in claim 1, wherein the at least one processor is configured to initiate a timer on receiving the user input to select one of the plurality of speed modes and the one more conditions are satisfied.

8. The device as claimed in claim 7, wherein the at least one processor is configured to determine that a predetermined amount of time, determined by the timer, has lapsed and in response thereto to change the speed mode to a different or stationary speed mode.

9. The device as claimed in claim 1, wherein the at least one processor is configured to determine that the user input to select one of the plurality of speed modes when the one or more conditions are satisfied has ended and in response thereto to change the speed mode to a different or stationary speed mode.

10. The device as claimed in claim 1, wherein the at least one processor is configured to determine that the use of the selected speed mode has ended and in response thereto to trigger an effect associated with at least one game object

11. The device as claimed in claim 10, wherein the received input to select one of the plurality of speed modes selects one of the game objects to have the selected speed mode and the at least one processor is configured to trigger the effect associated with the selected one game object.

12. A computer implemented method for providing a computer implemented game having a plurality of game objects which in use are displayed on a display of a computer implemented device, the method comprising:
receiving an input from a user to select one of a plurality of speed modes for one or more game objects;
causing a display to display the plurality of game objects
responsive to the received input to select one of a plurality of speed modes, determining if one or more conditions are satisfied; and
if the one more conditions are satisfied, controlling movement of at least one of the plurality of game objects when displayed on the display in dependence on the speed mode selected by the user input.

13. The method as claimed in claim 12, comprising detecting at least one event associated with at least one object, the one or more conditions being associated with the at least one event.

14. The method as claimed in claim 13, comprising detecting at least one event by determining a collision of at least one object with at least one other object.

15. The method as claimed in claim 13, comprising storing information associated with at least one of a number of events and a value associated with the one or more events in a memory.

16. The method as claimed in claim 15, comprising determining if the number of events or the value satisfies the one or more conditions.

17. The method as claimed in claim 12, comprising selecting a slower one of the speed modes, on receiving the input from the user to select one of the plurality of speed modes.

18. The method as claimed in claim 12, comprising initiating a timer on receiving the user input to select one of the plurality of speed modes and the one more conditions are satisfied, and determining that a predetermined amount of time, determined by the timer, has lapsed and in response thereto to changing the speed mode to a different or stationary speed mode.

19. The method as claimed in claim 12, comprising selecting one or the game objects to have the selected one of the plurality of speed modes in response to the input from the user, determining that the selected speed mode has ended and the at least one processor is configured to trigger an effect associated with the selected one game object.

20. A non-transitory computer readable medium comprising computer executable instructions which when run by at least one processor are configured to:
receive an input from a user to select one of a plurality of speed modes for one or more game objects;
cause a display to display the plurality of game objects
responsive to the received input to select one of a plurality of speed modes, determine if one or more conditions are satisfied; and
if the one more conditions are satisfied, control movement of at least one of the plurality of game objects when displayed on the display in dependence on the speed mode selected by the user input.
